(19) United States
(12) Patent Application Publication
(10) Pub. No.: US 2025/0087816 A1
(43) Pub. Date: Mar. 13, 2025

(54) BATTERY PACK AND METHOD FOR MANUFACTURING BATTERY PACK

(71) Applicant: TOYOTA JIDOSHA KABUSHIKI KAISHA, Toyota-shi (JP)

(72) Inventor: Shigeyuki INOUE, Toyota-shi (JP)

(21) Appl. No.: 18/785,269

(22) Filed: Jul. 26, 2024

(30) Foreign Application Priority Data
Sep. 12, 2023 (JP) 2023-147867

(51) Int. Cl. H01M 50/264; H01M 10/653; H01M 50/202

(52) U.S. Cl. CPC H01M 50/264; H01M 10/653; H01M 50/202

(57) ABSTRACT

A battery pack includes: a battery cell; and a case having a bottom plate to which the battery cell is joined with an adhesive. Further, the bottom plate has a deformable portion in a portion other than an adhesive application region.

### CROSS-REFERENCE TO RELATED APPLICATION(S)

The present application claims priority to and incorporates by reference the entire contents of Japanese Patent Application No. 2023-147867 filed in Japan on Sep. 12, 2023.

### BACKGROUND

The present disclosure relates to a battery pack and a method for manufacturing a battery pack.

Japanese Laid-open Patent Publication No. 2016-535423 discloses a battery pack including at least one elastic element disposed at the bottom of a housing so as to hold a heat exchanger against a battery.

### SUMMARY

There is a need for providing a battery pack and a method for manufacturing a battery pack capable of reducing the number of parts.

According to an embodiment, a battery pack includes: a battery cell; and a case having a bottom plate to which the battery cell is joined with an adhesive. Further, the bottom plate has a deformable portion in a portion other than an adhesive application region.

According to an embodiment, a method for manufacturing a battery pack includes: a step of applying an adhesive to a bottom plate having a deformable portion in a portion other than a predetermined adhesive application region; a step of placing a battery cell on the bottom plate to which the adhesive is applied; and a step of joining the battery cell and the bottom plate while pushing and spreading the adhesive between the battery cell and the bottom plate by pressing a jig from below the bottom plate.

### BRIEF DESCRIPTION OF THE DRAWINGS

FIG. 1 is a schematic view illustrating an example of a configuration of a battery pack according to an embodiment;

FIG. 2 is a schematic view illustrating an example of a battery cell joining step in a method for manufacturing a battery pack according to the embodiment; and

FIG. 3 is a schematic view illustrating an example of the battery cell joining step in the method for manufacturing a battery pack according to the embodiment.

### DETAILED DESCRIPTION

In the configuration disclosed in Japanese Laid-open Patent Publication No. 2016-535423, since it is necessary to separately provide the elastic element, the number of parts increases.

A battery pack and a method for manufacturing a battery pack according to an embodiment of the present disclosure will be described with reference to the drawings. Note that the constituent elements in the following embodiment include those that can be easily replaced by those skilled in the art or those that are substantially the same.

### Battery Pack

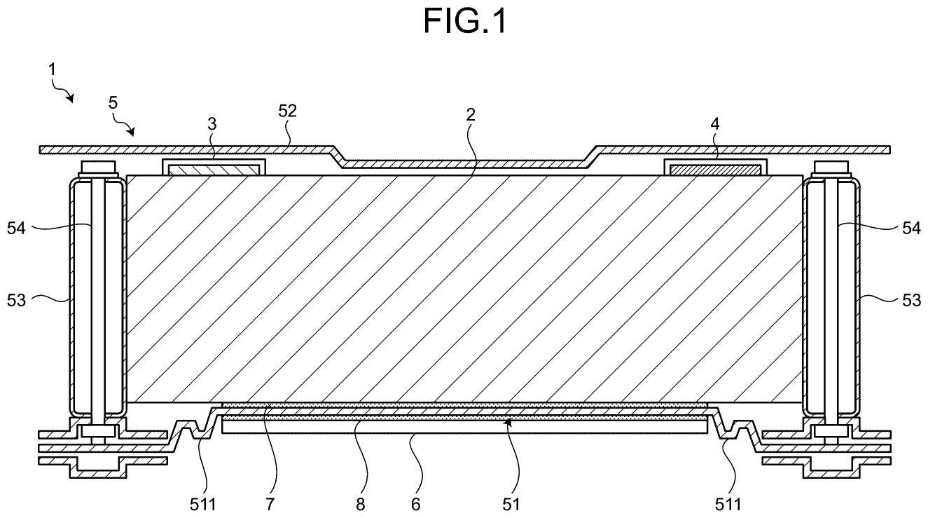

A configuration of the battery pack according to the embodiment will be described with reference to FIG. 1. The battery pack according to the embodiment is an on-vehicle battery pack mounted on, for example, a hybrid electric vehicle (HEV), a plug-in hybrid electric vehicle (PHEV), a battery electric vehicle (BEV), or the like.

The battery pack 1 according to the embodiment includes a battery cell 2, a case 5, and a cooler 6.

The battery cell 2 is a chargeable and dischargeable secondary battery. The battery cell 2 includes two terminals 3 and 4. One of the terminals 3 and 4 is a positive electrode terminal, and the other is a negative electrode terminal. Note that the battery pack 1 may include, instead of the battery cell 2, a battery module in which the battery cells 2 are connected in series or in parallel.

The case 5 includes a bottom plate (lower case) 51, an upper plate (upper cover) 52, and side members 53. The bottom plate 51 is formed of a metal thin plate. The battery cell 2 is joined to an upper surface of the bottom plate 51 with an adhesive 7. In addition, the cooler 6 is joined to a lower surface of the bottom plate 51 with an adhesive 8. In addition, these adhesives 7 and 8 are thermally conductive adhesives. As described above, a heat dissipation effect can be improved by using the thermally conductive adhesive as the adhesives 7 and 8.

The bottom plate 51 has a deformable portion 511 in a portion other than a predetermined application region (hereinafter, referred to as an “adhesive application region”) of the adhesives 7 and 8. The deformable portion 511 is formed in a wavy shape in cross section.

By providing the deformable portion 511 to the bottom plate 51 in this manner, the rigidity of the bottom plate 51 formed of a thin plate having low rigidity is further reduced. As a result, in a battery cell joining step of the method for manufacturing a battery pack described later, when the adhesive 7 is pushed and spread by the battery cell 2, the bottom plate 51 is easily deformed, and the upper surface of the bottom plate 51 is easily attached to a lower surface of the battery cell 2. As a result, the thickness of the adhesive 7 can be made uniform, and the adhesive 7 can be thinly applied.

The upper plate 52 is formed of a metal thin plate. A fastening member 54 for fixing the side member 53 to the bottom plate 51 is provided inside the side member 53.

The cooler 6 is a member for dissipating heat generated from the battery cell 2 to the outside. The cooler 6 is formed in a plate shape and is joined to the lower surface of the bottom plate 51 via the adhesive 8.

### Method for Manufacturing Battery Pack

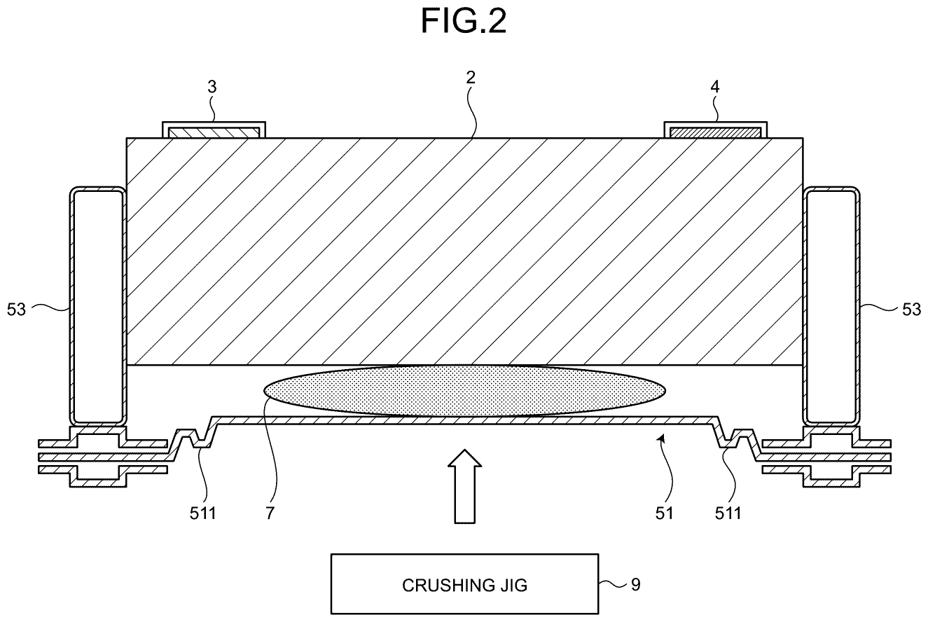

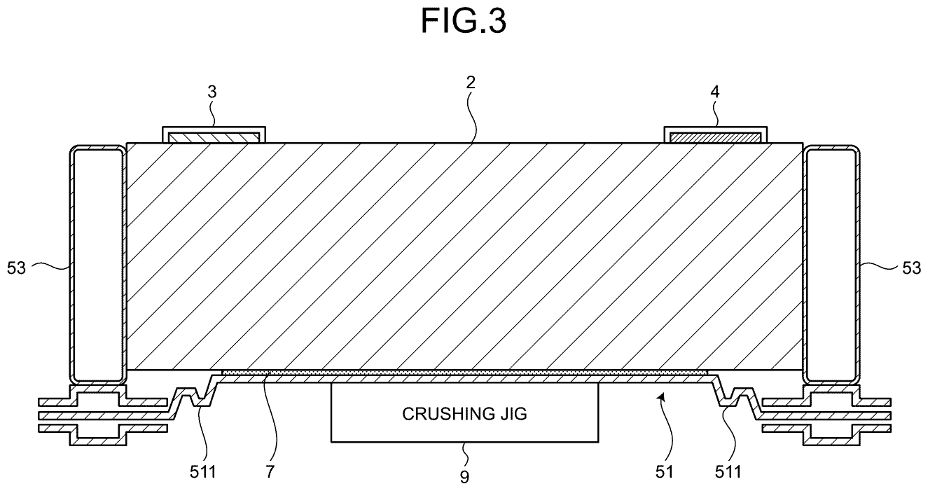

The method for manufacturing a battery pack according to the embodiment will be described with reference to FIGS. 2 and 3. The method for manufacturing a battery pack according to the embodiment includes an adhesive applying step, a battery cell placing step, the battery cell joining step, and a cooler joining step.

### Adhesive Applying Step

In the adhesive applying step, as illustrated in FIG. 2, the adhesive 7 is applied onto the bottom plate 51. As described above, the bottom plate 51 has the deformable portion 511 having a wavy shape in the portion other than the predetermined adhesive application region.

### Battery Cell Placing Step

In the battery cell placing step, the battery cell 2 is placed on the bottom plate 51 to which the adhesive 7 is applied in the adhesive applying step.

### Battery Cell Joining Step

In the battery cell joining step, as illustrated in FIGS. 2 and 3, by pressing a crushing jig 9 from below the bottom plate 51, the battery cell 2 and the bottom plate 51 are joined while the adhesive 7 between the battery cell 2 and the bottom plate 51 is pushed and spread (crushed).

Here, since a bottom plate of a case of a battery pack is generally a thin plate and has low rigidity, it is difficult to ensure the flatness of the bottom plate. Therefore, when a battery cell is joined to the bottom plate having a flat plate shape, the thickness of an adhesive on a bonding surface between the battery cell and the bottom plate becomes non-uniform or the adhesive is thickly applied, which may deteriorate cooling performance.

On the other hand, the bottom plate 51 according to the embodiment is provided with the deformable portion 511 in the portion other than the adhesive application region. Therefore, in the battery cell joining step, when the adhesive 7 is pushed and spread by the battery cell 2, the bottom plate 51 is easily deformed, and the upper surface of the bottom plate 51 is easily attached to the lower surface of the battery cell 2. As a result, the thickness of the adhesive 7 can be made uniform, and the adhesive 7 can be thinly applied.

### Cooler Joining Step

In the cooler joining step, the cooler 6 to which the adhesive 8 is applied is joined below the bottom plate 51.

According to the battery pack according to the embodiment described above, since the deformable portion 511 is provided to the bottom plate 51 itself, it is not necessary to separately provide an elastic element, and the number of parts can be reduced. In addition, according to the method for manufacturing a battery pack according to the embodiment, since the adhesive 7 between the battery cell 2 and the bottom plate 51 can be uniformly pushed and spread to be thinly applied, it is possible to reduce the cost and improve a cooling effect. Further, according to the battery pack and the method for manufacturing a battery pack according to the embodiment, the heat dissipation effect can be improved by using the thermally conductive adhesive as the adhesives 7 and 8.

In addition, in the battery pack and the method for manufacturing a battery pack according to the embodiment, the rigidity of the bottom plate 51 formed of a thin plate is further reduced by providing the deformable portion 511 to the bottom plate 51. As a result, by applying a load from below the bottom plate 51 by the crushing jig 9 at the time of manufacturing (assembling) the battery pack 1, the adhesive 7 in contact with a plane (adhesive application region) of the bottom plate 51 can be uniformly crushed. As a result, the adhesive 7 can be thinly applied as described above, and the cooling performance can be enhanced by a decrease in thermal resistance while reducing the cost price and mass.

In addition, in the battery pack and the method for manufacturing a battery pack according to the embodiment, since distortion generated at the time of manufacturing (assembling) the battery pack 1 can be absorbed by the deformable portion 511 having a wave shape, the flatness of the bottom plate 51 can be improved. The adhesive 7 can be thinly applied, and the cooling performance can be enhanced by a decrease in thermal resistance while reducing the cost price and mass.

According to the battery pack according to the present disclosure, since the deformable portion is provided to the bottom plate itself, it is not necessary to separately provide an elastic element, and the number of parts can be reduced. In addition, according to the method for manufacturing a battery pack according to the present disclosure, since the adhesive between the battery cell and the bottom plate can be uniformly pushed and spread to be thinly applied, it is possible to reduce the cost and improve a cooling effect.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a battery cell; and
a case having a bottom plate to which the battery cell is joined with an adhesive, wherein
the bottom plate has a deformable portion in a portion other than an adhesive application region.

2. The battery pack according to claim 1, wherein the adhesive is a thermally conductive adhesive.

3. A method for manufacturing a battery pack, the method comprising:
a step of applying an adhesive to a bottom plate having a deformable portion in a portion other than a predetermined adhesive application region;
a step of placing a battery cell on the bottom plate to which the adhesive is applied; and
a step of joining the battery cell and the bottom plate while pushing and spreading the adhesive between the battery cell and the bottom plate by pressing a jig from below the bottom plate.
